(19) United States
(12) Patent Application Publication
(10) Pub. No.: US 2025/0377237 A1
(43) Pub. Date: Dec. 11, 2025

(54) RPM DETECTION OF ROTATING EQUIPMENT ON EDGE USING CONFIGURABLE MEMS BASED CAPACITIVE ACCELEROMETER

(71) Applicant: Honeywell International Inc., Charlotte, NC (US)

(72) Inventors: Satish Mohanty, Hyderabad (IN); Sarabjit Singh, Hyderabad (IN); Ranganathan Srinivasan, Chennai (IN)

(21) Appl. No.: 18/765,197

(22) Filed: Jul. 5, 2024

(30) Foreign Application Priority Data
Jun. 10, 2024 (IN) 202411044787

(51) Int. Cl. G01H 1/00; G01M 13/045; G01P 15/125

(52) U.S. Cl. CPC G01H 1/003; G01M 13/045; G01P 15/125

(57) ABSTRACT

A method, system and sensor apparatus for estimating RPM of rotating machinery, can involve acquiring vibration data from an accelerometer sensor mounted on the rotating machinery and detecting vibration signals from the acquired vibration data. A Fast Fourier Transform (FFT) can be performed on the detected vibration signals for conversion of the detected vibration signals from a time domain to a frequency domain. An RPM of the rotating machinery can be estimated from the frequency domain, and fault frequences can be calculated using the estimated RPM and a bearing configuration provided by a user. A health diagnosis of the rotating machinery can be based on the calculated fault frequencies and an analysis of the detected vibration signals. In an embodiment, accelerometer sensor can be implemented as a MEMS capacitive accelerometer sensor.

### CROSS-REFERENCE TO RELATED PATENT APPLICATION

This patent application claims priority to Indian Provisional Patent Application No. 202411044787, filed Jun. 10, 2024, which is incorporated herein by reference in its entirety.

### TECHNICAL FIELD

Embodiments are generally related to the field of industrial instrumentation and control, including the measurement and monitoring of rotational speeds in machinery and equipment. Embodiments further relate to sensor technologies, signal processing, and the integration of low-cost, low-power MEMS capacitive accelerometer sensors for non-intrusive revolution per minute (RPM) detection in industrial environments.

### BACKGROUND

The accurate detection of the revolution per minute (RPM) of rotating machinery is critical for various industrial applications, including maintenance, performance monitoring, and operational control. Traditionally, tachometers have been employed to measure the rotational speed of equipment. While effective, tachometers come with several limitations that can hinder their practical application in modern industrial settings.

FIG. 1 illustrates a block diagram depicting a conventional system 100 for estimating the RPM of rotating machinery such as a motor. The system shown in FIG. 1 includes a tachometer 94 and an accelerometer sensor 96 that can obtain data associated with the operations of the motor 82 from the motor 82. Output from the accelerometer sensor 96 can be provided to a vibration signal fast Fourier transform (FFT) module 94, which in turn outputs data that can be input to diagnosis module 96 for diagnosing the health status of the motor 82. Data output from the tachometer 96 can be input to a measured RPM module 90 for measuring RPM. Data from the measured RPM module 90 can be input to a fault frequency module 92 for calculating fault frequencies, which in turn can output data that is input to the diagnosis module 96 for use in diagnosing the motor 82. The system 100 can also include a bearing configuration 98 provided by a user.

Tachometers generally require direct access to the rotating shaft, which can be challenging and sometimes dangerous in operational environments. The installation process can be intrusive and labor-intensive, involving mechanical adjustments and precise alignment. This physical interaction with the machinery not only increases downtime but also introduces potential points of failure due to wear and tear.

Furthermore, tachometers such as tachometer 94 rely on optical or magnetic sensors that demand clean, obstruction-free environments to function accurately. Dust, oil, and other contaminants common in industrial settings can impair sensor performance, leading to erroneous readings or complete sensor failure. Additionally, the maintenance of these sensors can be costly and frequent, as they are susceptible to environmental degradation.

While traditional tachometers have served their purpose well, the need for a more adaptable, non-intrusive, and reliable method of RPM detection in rotating machinery has become increasingly evident. The disclosed solutions aims to address this these problems, while paving the way for smarter, more efficient industrial monitoring solutions.

### BRIEF SUMMARY

The following summary is provided to facilitate an understanding of some of the features of the disclosed embodiments and is not intended to be a full description. A full appreciation of the various aspects of the embodiments disclosed herein can be gained by taking the specification, claims, drawings, and abstract as a whole.

It is, therefore, one aspect of the embodiments to provide for an improved RPM estimate method and system.

It is another aspect of the embodiments to provide for a method and system involving the integration of low-cost, low-power MEMS capacitive accelerometer sensors for non-intrusive revolution per minute (RPM) detection in industrial environments.

It is a further aspect of the embodiments to provide for methods and systems for RPM detecting of rotating equipment on edge using a configurable MEMS based capacitive accelerometer.

The aforementioned aspects and other objectives can now be achieved as described herein. In an embodiment, a method for estimating RPM of rotating machinery, can involve: acquiring vibration data from an accelerometer sensor mounted on the rotating machinery; detecting vibration signals from the acquired vibration data; performing a Fast Fourier Transform (FFT) on the detected vibration signals for conversion of the detected vibration signals from a time domain to a frequency domain; estimating an RPM of the rotating machinery from the frequency domain; calculating fault frequencies using the estimated RPM and a bearing configuration; and diagnosing a health status of the rotating machinery based on the calculated fault frequencies and an analysis of the detected vibration signals.

In an embodiment, the bearing configuration can be provided by a user.

In an embodiment, the accelerometer sensor can include a MEMS capacitive accelerometer sensor.

An embodiment can further involve standardizing the vibration data across three axes.

An embodiment can further involve standardizing the vibration data across three axes to improve transient and DC offset correction.

An embodiment can further involve filtering the standardized vibration data using a bandpass filter determined by a predefined range and detecting peaks within the filtered vibration data to refine the estimation of the RPM.

In an embodiment, the aforementioned RPM estimation and fault diagnosis can be performed using an adaptive configurable ‘g’ setting to ensure accurate RPM determination under variable speeds and torque conditions using low cost sensing and processing system.

In an embodiment, a system for estimating the RPM of rotating machinery, can include at least one processor, and a non-transitory computer-usable medium embodying computer program code, the computer-usable medium capable of communicating with the at least one processor, the computer program code comprising instructions executable by the at least one processor and configured for: acquiring vibration data from an accelerometer sensor mounted on the rotating machinery; detecting vibration signals from the acquired vibration data; performing a Fast Fourier Transform (FFT) on the detected vibration signals for conversion of the detected vibration signals from a time domain to a frequency domain; estimating an RPM of the rotating machinery from the frequency domain; calculating fault frequencies using the estimated RPM and a bearing configuration; and diagnosing a health status of the rotating machinery based on the calculated fault frequencies and an analysis of the detected vibration signals.

In an embodiment, a sensor apparatus, can include an accelerometer sensor mounted on rotating machinery, wherein the accelerometer acquires vibration data from the rotating machinery and vibration signals are detected from the acquired vibration data, wherein a Fast Fourier Transform (FFT) can be performed on the detected vibration signals for conversion of the detected vibration signals from a time domain to a frequency domain, and the RPM of the rotating machinery can be estimated from the frequency domain. Furthermore, fault frequencies can be calculated using the estimated RPM and a bearing configuration. In addition, a health status of the rotating machinery can be diagnosed based on the calculated fault frequencies and an analysis of the detected vibration signals.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram depicting a conventional system for estimating the RPM of rotating machinery;

FIG. 2 illustrates a block diagram depicting a system for estimating the RPM of rotating machinery, in accordance with an embodiment;

FIG. 3 illustrates a block diagram of a system for RPM detection, which can be implemented in accordance with an embodiment;

FIG. 4 illustrates a flow chart of operations depicting logical operational steps of a method for RPM detecting of rotating equipment on edge using a configurable MEMS based capacitive accelerometer, in accordance with an embodiment;

FIG. 5 illustrates an image depicting an example bearing fault simulator system, which may be implemented in accordance with an embodiment;

FIG. 6 illustrates a graph depicting values as the RPM with respective harmonics indicative of a 0.007-inch defect at no load, in accordance with an example embodiment;

FIG. 7 illustrates a graph depicting values as the RPM with respective harmonics indicative of a 0.007-inch defect at 1 HP load, in accordance with an example embodiment;

FIG. 8 illustrates a graph depicting values as the RPM with respective harmonics indicative of a 0.007-inch defect at 2 HP load, in accordance with an embodiment;

FIG. 9 illustrates a table depicting data indicative of output for a CRWU data set, in accordance with an example embodiment;

FIG. 10 illustrates an image of an experimental bearing simulator setup, in accordance with an embodiment;

FIG. 11 illustrates a graph depicting time series data obtained from HVT and piezoelectric references sensors, in accordance with an embodiment;

FIG. 12 illustrates a graph depicting RPM values and associated harmonics for three channels of an HVT sensor and a reference sensor, in accordance with an embodiment;

FIG. 13 illustrates a graph depicting RPM values and associated harmonics for the reference sensor with and without a Hilbert Transform using the disclosed method, in accordance with an embodiment;

FIG. 14 illustrates a block diagram depicting a computer system, which may be adapted for use in accordance with an embodiment; and

FIG. 15 illustrates images of a test configuration conducted on a pump-motor setup using an HVT sensor at a variable speed.

In the drawings described and illustrated herein, identical or similar parts and elements are generally indicated by identical reference numerals.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other issues, subject matter may be embodied as methods, devices, components, or systems. Accordingly, embodiments may, for example, take the form of hardware, software, firmware, or a combination thereof. The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein may not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Generally, “or” if used to associate a list, such as A, B, or C, is intended to mean A, B, and C, here used in the inclusive sense, as well as A, B, or C, here used in the exclusive sense. In addition, the terms “one or more” or “at least one” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Furthermore, the term “at least one” as utilized herein can refer to “one or more”. For example, “at least one widget” may refer to “one or more widgets”.

The advent of Micro-Electro-Mechanical Systems (MEMS) technology offers a promising alternative to conventional sensing devices through the use of capacitive accelerometer sensors. MEMS accelerometers are compact, cost-effective, and consume significantly less power compared to traditional tachometric sensors. These sensors can be easily integrated into existing systems with minimal disruption.

MEMS capacitive accelerometers detect vibrations generated by rotating machinery. Since all rotating equipment produces characteristic vibration patterns, it is possible to derive the RPM by analyzing these vibrations. This method can provide a non-intrusive, contactless means of measuring rotational speed, circumventing many of the drawbacks associated with tachometers.

Despite their advantages, MEMS accelerometers also present challenges. The primary issue lies in the accurate extraction of RPM data from the complex vibration signals they generate. Vibration data can be noisy and contain multiple frequencies due to various operational and environmental factors. Hence, sophisticated signal processing algorithms are required to isolate the RPM frequency from the background noise and other harmonic frequencies.

To address these challenges, there is a pressing need for an innovative solution that leverages the capabilities of low-cost and low-power MEMS capacitive accelerometer sensors. This solution must include robust algorithms for the precise detection and analysis of vibration data to reliably determine the RPM of rotating machinery. Such advancements would enable more efficient and cost-effective monitoring and maintenance of industrial equipment, enhancing operational efficiency and reducing downtime.

As will be discussed in greater detail, embodiments relate to an edge-supported RPM estimation method and system that can leverage vibration data from accelerometers. This innovative approach requires minimal memory and is computationally less complex compared to traditional methods. One of the key advantages is its impressive accuracy, which exceeds 95%. Furthermore, this solution is versatile and effective for variable speed measurements, eliminating the need for thresholding. It operates reliably regardless of the sensor's orientation, significantly reducing the false positive rate. Additionally, it performs consistently under various loading conditions and across different states of the machine, whether healthy or faulty. The method is applicable to a wide range of rotating equipment, including bearings, motors, pumps, and blowers. Moreover, the system's effectiveness can be validated using both open datasets and in-house data collected through academic collaboration, maintaining a confidence accuracy of 95%. This robust approach offers a significant improvement in RPM detection, making it a valuable tool in industrial monitoring and control applications.

Note that the term “edge” or “Edge” as utilized herein can relate to “Edge” hardware device, which can be implemented as a sophisticated hardware component equipped with embedded software designed to perform data processing and computing tasks close to the source of data generation, often referred to as the “edge” of the network. These devices can play a critical role in modern distributed computing environments, bridging the gap between local data sources and centralized cloud systems.

An Edge device can be integrated with embedded software, which can include operating systems, middleware, and specific applications tailored for real-time data processing and analysis. This software can be optimized for the device's hardware to ensure efficient performance and reliability. The Edge device can also be connected to the network through physical means such as Ethernet cables, providing stable and high-speed data transfer. Alternatively, the Edge device can support wireless connectivity options, including Wi-Fi, Bluetooth, LTE, and 5G, enabling flexible deployment in various environments without the need for extensive cabling. An Edge device can also process data locally, reducing latency and bandwidth usage by filtering, aggregating, and analyzing data at the source. This can enable real-time decision-making and faster response times for critical applications.

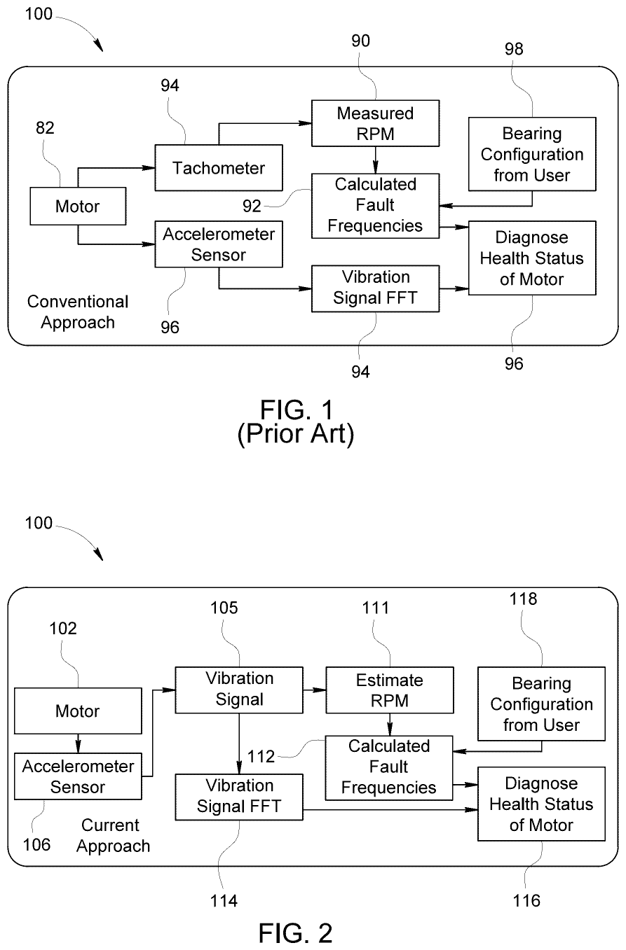

FIG. 2 illustrates a block diagram depicting a system 101 for estimating the RPM of rotating machinery such as a motor, in accordance with an embodiment. The system 101 shown in FIG. 2 includes an accelerometer sensor 106 that detects acceleration data output from the motor 102. The system 101 also includes a vibration signal processing module 105 that can detect vibration signals output from the accelerometer sensor 106. The data output from the vibration signal processing module 105 can be subject to a vibration signal FFT 114, which in turn can output data that is input to the diagnosis module 116 for diagnosing the health status of the motor 102.

Note that data output from the vibration signal processing module 105 can also be input to an RPM estimation module 111. Data from the RPM estimation module 111 can be then input to a fault frequency module 112 for calculating fault frequencies, which in turn can output data that is input to the diagnosis module 116 for use in diagnosing the motor 102. The system 118 can also include a bearing configuration 118 provided by a user. Data from the bearing configuration 118 can be input to the fault frequency module 112. The system 101 thus uses vibration signals rather than the conventional tachometer or magnetometer of the conventional system 100 shown in FIG. 1, to estimate the RPM of rotating machineries.

The system 101 shown in FIG. 2 can be implemented such that the RPM can be used as the input for calculations of fault frequencies, and further these frequencies can be used to diagnose health status of a machine/DUT (Device Under Test). The accelerometer shown in FIG. 2 can be implemented as a MEMS accelerometer sensor. Note that a single three axes' MEMS accelerometer sensor can be used for measurement of RPM and fault diagnosis simultaneously. The system 101 also does not require an extra RPM detection sensor and/or additionally power or cabling required for conventional systems. In addition, system 101 can be implemented with lower costs than that of conventional systems such as the previously discussed system 100 shown in FIG. 1.

The system 101 shown in FIG. 2 can function with algorithms working at variable speeds and torque conditions. The system 101 also does not require hard-coded thresholding. Furthermore, the system 101 can be configured to function with an adaptive configurable ‘g’ setting to determine the actual RPM. The system 101 is also computationally fit for low and edge-based controllers. The system 101 can also operation with a boundary condition involving a required name plate RMP of the rotating device (e.g., motor 102) as the input to the method/algorithm.

Note that the aforementioned “adaptive configurable ‘g’ setting” relates to a flexible parameter within the method for estimating the RPM of rotating machinery that can be adjusted based on the operational conditions. This setting, denoted as ‘g’, can be designed to adapt to changes in speed and torque of the machinery, ensuring accurate RPM estimation under varying conditions. Specifically, the adaptive configurable ‘g’ setting may involve a setting that can be dynamically adjusted in real-time to accommodate fluctuations in the machinery's operating environment.

Users or the system 101 can, for example, configure this parameter based on predefined criteria or through machine learning algorithms that optimize the setting for specific scenarios. By adapting the ‘g’ setting, the system 101 can improve the accuracy of the RPM estimation, even when the machinery experiences significant variations in speed or load. This adaptability may be crucial for maintaining precise RPM estimation and fault diagnosis, particularly in environments where machinery does not operate at a constant speed or under consistent torque conditions.

The system 101 can implement edge-supported RPM estimation method that can leverage the capabilities of MEMS sensors, providing an accurate, non-intrusive, and versatile means of monitoring and diagnosing industrial equipment. This system's minimal memory requirement, computational efficiency, and ability to operate reliably under various conditions make it a valuable tool for enhancing operational efficiency and reducing downtime in industrial applications. The innovative approach of using vibration data for RPM estimation and fault diagnosis, validated through open and in-house datasets, underscores its potential for widespread adoption in the industry.

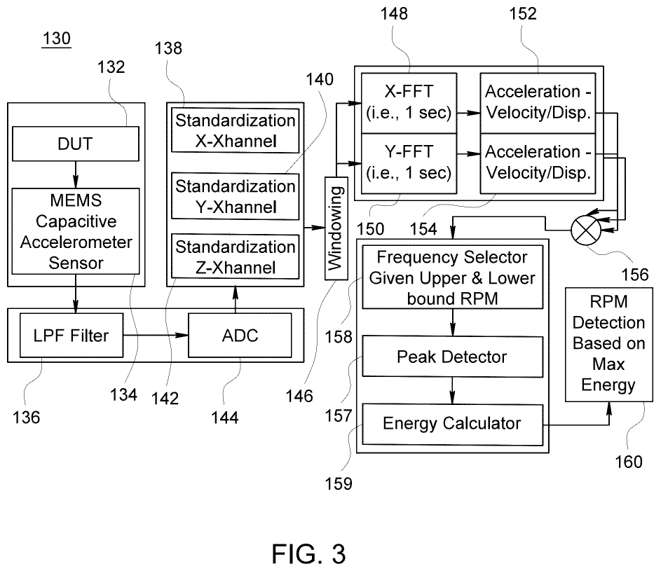

FIG. 3 illustrates a block diagram of a system 130 for RPM detection, which can be implemented in accordance with an embodiment. The system 130 can include a DUT 132 that provides data that can be input to a MEMS capacitive accelerometer sensor 134. Data output from the MEMS capacitive accelerometer sensor 134 can be input to an LPF filter 136. Data output from the LPF filter 136 can be then input to an analog-to-digital controller (ADC) 144 that can output data to three channels of, for example, an HVT sensor and/or a reference sensor.

These three channels can include a standardization X-Channel 138, a standardization Y-Channel 140, and a standardization Z-Channel 142. Data output from the standardization X-Channel 138, the standardization Y-Channel 140, and the standardization Z-Channel 142 can be input to a windowing application 146, which in turn can output data subject to an X-FFT 148 (e.g., 1 second) and a Y-FFT (e.g., 1 second) 150 (as discussed previously FFT refers to “Fast Fourier Transform). Windowing can be performed by the windowing application 146 with respect to all three standardized data (i.e., X-Channel 138, Y-Channel 140, Z-Channel 142) to avoid spectral leakage and transient present in the vibration signal.

Data output from the X-FFT 148 can be subject to an acceleration-velocity/displacement conversion module 152. Likewise, data output from the Y-FFT 150 can be subject to an acceleration-velocity/displacement conversion module 154. Data output from the acceleration-velocity/displacement antialiasing filter 152 and the acceleration-velocity/displacement conversion module 154 can be provided to a multiplier 156 and then to a frequency selector 158 (given upper and lower bound RPM), which can then output data that is input to a peak detector 157.

Data output from the peak detector 157 can be then input to an energy calculation module 159, which can perform an energy calculation with respect to the provided data. The energy calculation data generated by the energy calculation module 159 can be then subject to RPM detection 160 based on a maximum energy.

Note that the various blocks shown in FIG. 3 can be sliced into a procedural flow to determine RPM from accelerometer data as follows. The sampled 3-channel vibration data (acceleration; X, Y & Z) received are standardized (STD) to detect changes in the signal pattern irrespective of amplitude, offset filtering and consistency across all the channels.

$$S T {D}_{X} = \frac{X - \overline{X}}{{σ}_{X}} \qquad ( 1 )$$

$${STD}_{Y} = \frac{Y - \overline{Y}}{{σ}_{Y}} \qquad ( 2 )$$

$${STD}_{Z} = \frac{Z - \overline{Z}}{{σ}_{Z}} \qquad ( 3 )$$

Where STD_{X}, STD_{Y} & STD_{z} are the standardized vibration signals of the three channels.

As discussed above, windowing can be accomplished with respect to all three standardized data to avoid spectral leakage and transient present in the vibration signal. Signal fluctuation due to variation in the load and RPM can be controlled using proper selection of the window based on the applications. The windowed signals are indicated by Equations 4,5 and 6 below

$${WS}_{X} = {STD}_{X} \cdot {W}_{Hann} \qquad ( 4 )$$

$${W S}_{Y} = {STD}_{Y} \cdot {W}_{Hann} \qquad ( 5 )$$

$${W S}_{Z} = {STD}_{Z} \cdot {W}_{Hann} \qquad ( 6 )$$

Where WS_{X}, WS_{Y}, WS_{z} are the windowed time series signal and W_{Hann} is the Hanning window.

The windowed time domain signals can be converted to their respective frequency domain using as in Equations 7,8 and 9 shown below.

$${X}_{k} = {\sum }_{n = 0}^{N - 1} W {S}_{X} ( n ) \cdot {W}_{N}^{k n} , k = 0 , 1 , … N - 1 \qquad ( 7 )$$

$${Y}_{k} = {\sum }_{n = 0}^{N - 1} {WS}_{Y} ( n ) \cdot {W}_{N}^{kn} , k = 0 , 1 , … N - 1 \qquad ( 8 )$$

$${Z}_{k} = {\sum }_{n = 0}^{N - 1} {WS}_{Z} ( n ) \cdot {W}_{N}^{kn} , k = 0 , 1 , … N - 1 \qquad ( 9 )$$

Where Xₖ Yₖ & Zₖ are the FFT of the three vibration channels.

The FFT signals for X, Y, Z can be translated to their respective velocity/displacement as per DUT condition and LPF filter characteristics (antialiasing filter) response 136.

$$X {v}_{k} = \frac{{X}_{k}}{2 \cdot pi \cdot f} ∀ f = \frac{nfs}{N} ; n = 0 , … N - 1 \qquad ( 10 )$$

$${Yv}_{{k}_{}} = \frac{{Y}_{k}}{2 \cdot pi \cdot f} ∀ f = \frac{nfs}{N} ; n = 0 , … N - 1 \qquad ( 11 )$$

$$Z {v}_{k} = \frac{{X}_{k}}{2 \cdot pi \cdot f} ∀ f = \frac{nfs}{N} ; n = 0 , … N - 1 \qquad ( 12 )$$

Where Xvₖ Yvₖ & Zvₖ are the velocity data for the three channels in the frequency domain.

Furthermore, the velocity data in the frequency domain can be multiplied (i.e., channels that are parallel to the ground) to create a new signal in the frequency domain. The condition depends on the mounting and sensor type also and direction of propagation of the wave.

$$X N {v}_{k} = X {v}_{k} \cdot {Yv}_{k} ( OR ) {Yv}_{k} \cdot {Zv}_{k} ( OR ) {Zv}_{k} \cdot {Xv}_{k} \qquad ( 13 )$$

Where XNvₖ is the new velocity signal in frequency domain.

The new signal, XNvₖ can be passed through a bandpass filter. The filter bandwidth is decided based on the name plate RPM (NRPM) obtained from the user. Filter bandwidth is within (0.4*NRPM/60)<f<(3.2*NRPM/60).

$$XF = \{ \begin{matrix}{XNv}_{k} , & \frac{0.4 * NRPM}{60} \leq f \leq \frac{3.2 * NRPM}{60} \\ 0 , & Otherwise\end{matrix} \qquad ( 14 )$$

Where XF is the new filtered signal.

Operations can also be implemented to detect peaks/local maxima of the filtered signals and create new signal consisting of the peaks XP, and rest of the point are zero. This operation can be carried out to avoid the adjacent sideband energy being leaked to the peaks. Note that the peak detector 157 shown in FIG. 3 is involved in this operation.

The peaks detected are within the filter bandwidth. However, for the energy calculation the frequency can be swiped from (0.4*NRPM/60) to (NRPM/60). The starting and ending index can be found for (0.5*NRPM/60) to (NRPM/60) with an assumption of 'j & k:

$${E}_{I} = XP ( I ) + X P ( 2 I ) + X P ( 3 I ) \\ I = j , j + 1 , … k \qquad ( 15 )$$

In addition, the energy value can be stored at each index in an array and the index found at which the energy is maximum. Finally, find the peak frequency can be determined at the index where the energy is maximum and it's the frequency of revolution of the machine in Hz. The value can be then converted to RPM by multiplying by a factor of, for example, 60.

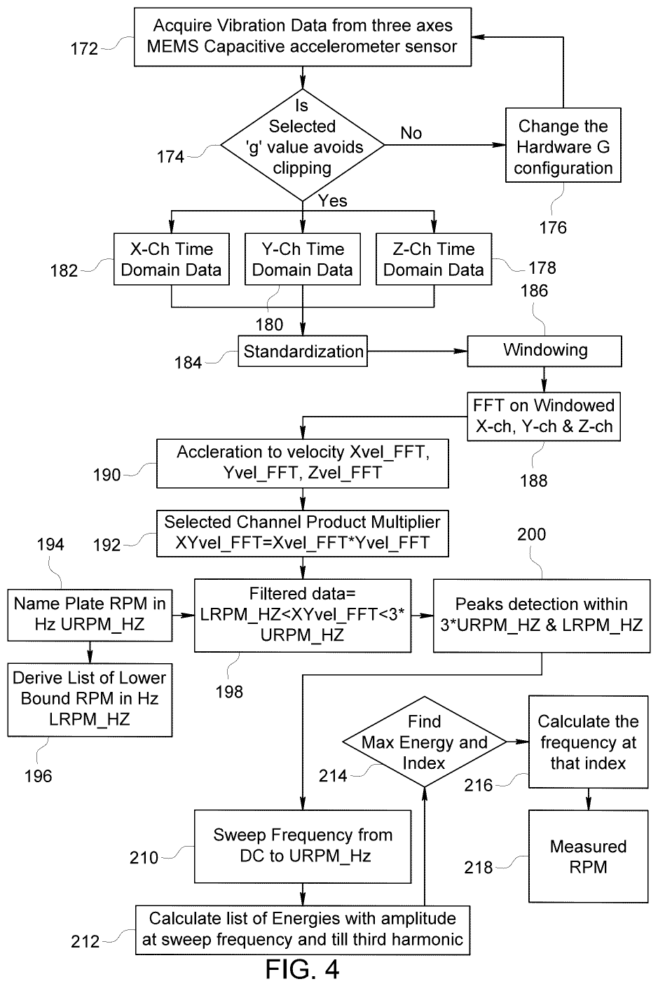

FIG. 4 illustrates a flow chart of operations depicting logical operational steps of a method 170 for RPM detecting of rotating equipment on edge using a configurable MEMS based capacitive accelerometer, in accordance with an embodiment. As shown at block 172, a step or operation can be implemented to acquire vibration data from a three-axes MEMS capacitive acceleration sensor. Next, as shown at decision block 174, a test can be performed to determine if a selected ‘g’ value avoids clipping. If not, then as shown at block 176, a step or operation can be performed to change the hardware G configuration, followed by processing again of the step or operation depicted at block 172. If, however, the answer is “yes” with respect to processing of the step or operation depicted at decision block 174, then steps or operation can be performed involving X-Channel time domain data 182, Y-Channel time domain data 180, and Z-Channel time domain data 178.

Thereafter, as shown at block 184, a step or operation can be implemented involving data standardization as discussed previously, followed by a windowing operation as shown at block 186. Following implementation of the windowing operation shown at block 186 by, for example, the windowing application 146 shown in FIG. 3, an step or operation can be implemented to perform an FFT on the windowed X-Channel data, Y-Channel data, and Z-Channel data, as shown at block 188.

Next, as depicted at block 190, a step or operation can be implemented involving acceleration to velocity including Fast Fourier Transforms Xvel_FFT, Yvel_FFT, and Zvel_FFT. Thereafter, as indicated at block 192, a step or operation can be performed involving a selected channel product multiplier operation including XYvel_FFT=Xvel_FFT*Yvel_FFT. Following processing of the operation shown at block 192, a filter operation can be implemented as shown at block 198 involving Filtered data=LRPM_Hz<XYvel_FFT<3*URPM_HZ. Then, as shown at block 200, a peak detecting operation can be implemented involving peak detection within 3*URPM_HZ and LRPM HZ.

Thereafter, as indicated at block 210, a step or operation can be implemented involving a sweep frequency from DC (or) LRPM_Hz to URPM_Hz, following by a step or operation as shown at block 212 involving calculation of a list of energies with an amplitude as the sweep frequency until reaching a third harmonic. Next, as shown at decision block 214, a test can be performed to find the maximum energy and index. Thereafter, as depicted at block 216, a step or operation can be performed to calculate the frequency at that index. The measured RPM can be then determined as shown at block 218.

Two additional steps or operations can be performed. For example, as shown at block 194, a step or operation can be implemented involving “name plate” RPM in Hz (NRPM_Hz or URPM_Hz). Data output from the operation shown at block 194 can be provided as input to the step or operation depicted at block 198. Data output from the operation shown at block 194 can also be subject to a step or operation as shown at block 196, involving deriving a list of lower bound RPM in Hz (LRPM_Hz).

Note that the PRM estimation approach described herein has been tested on piezoelectric sensors as well as with MEMS capacitive accelerometer sensor data used in an example R110 HVT device. This approach has also been tested on open datasets from, for example, Case Western Reserve University (CWRU) as well as a fault simulator setup at the Indian Institute of Technology Madars (IITM). It should be appreciated that such setups and test datasets are not considered limiting features of the embodiments and any reference to these specific setups and datasets are discussed herein for exemplary and illustrative purposes only.

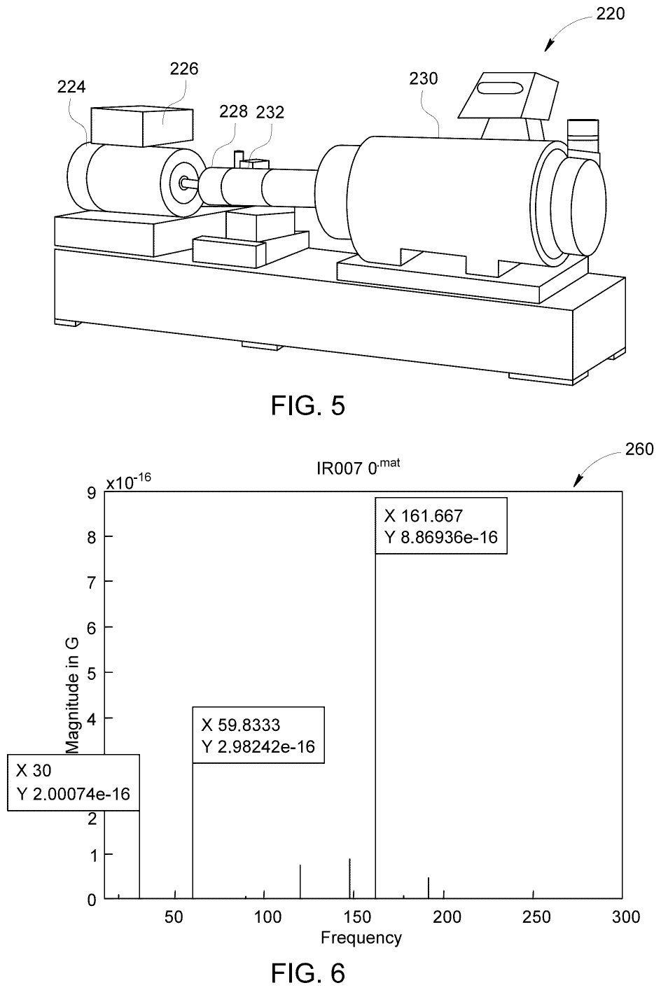

FIG. 5 illustrates an image depicting an example bearing fault simulator system, 220 which may be implemented in accordance with an embodiment. The bearing fault simulator system 220 (which may also be referred to as bearing fault simulator setup) can include a fan and bearing 224, an electric motor 226, a drive and bearing 228, a torque transducer and encoder 232, along with a dynamometer 230.

FIG. 6 illustrates a graph 260 depicting values as the RPM with respective harmonics indicative of a 0.007-inch defect at no load, in accordance with an example embodiment. Graph 260 represents an example scenario where a defect of 0.007 inches is present in the rotating machinery. Graph 260 shows the RPM and its harmonics, illustrating how the defect manifests at specific rotational speeds. The presence of a 0.007-inch defect results in characteristic peaks at specific harmonic frequencies. These peaks indicate the fundamental frequency and its multiples, which can be affected by the defect size. Higher harmonics suggest increased vibration energy due to the defect, and their amplitude can provide insight into the severity and nature of the defect.

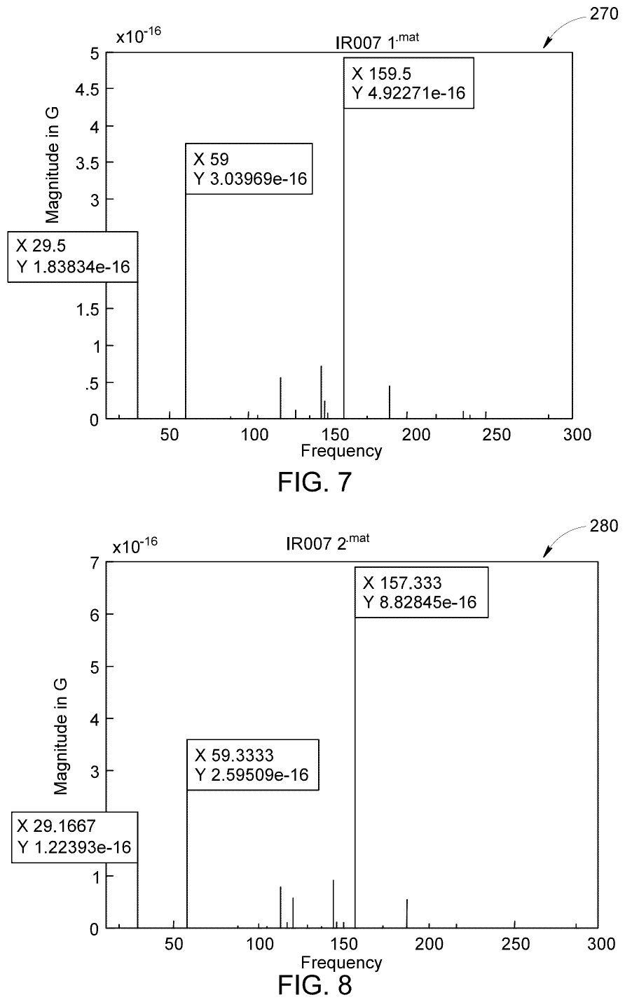

FIG. 7 illustrates a graph 270 depicting values as the RPM with respective harmonics indicative of a 0.007 inch defect at 1 HP Load, in accordance with an example embodiment. Similar to the previous graph 260, the graph 270 depicts one plots RPM against the harmonics for a higher torque. The increased torque can result in more pronounced harmonic peaks and changes in the RPM. Graph 270 indicates that as the load increases to 1 HP, the energy at the harmonics becomes more significant and increases in noise as well. This implies more severe vibrations and potential damage to the machinery.

FIG. 8 illustrates a graph 280 depicting values as the RPM with respective harmonics indicative of a 0.007 inch defect at 2 HP load, in accordance with an embodiment. Graph 280 depicts the relationship between RPM and harmonics for the higher load in the series. The harmonic peaks are even more pronounced and numerous, reflecting a significant increase in vibration energy due to load.

Graphs 260, 270, and 280, as illustrated in FIGS. 6, 7, and 8 therefore respectively, depict the RPM values with respective harmonics indicative of increase in load in a rotating machinery system. These graphs provide a visual representation of the relationship between RPM and variation in load, utilizing the system 101 described herein and/or the various approaches such as shown in the other figures herein. Across the graphs260, 270, and 280, there is a clear trend that as the load increases the RPM value shift from one frequency to another and noise floor will increase substantially. This demonstrates the system's sensitivity in detecting and quantifying the impact of load variation on the RPM.

The disclosed embodiments also offer the ability to estimate RPM and diagnose defects using vibration data is validated through these graphs. The increasing severity of defects is also impacted by the load variation and can be analyzed from the harmonic content of the vibration signals. These insights are crucial for predictive maintenance and early fault detection in industrial applications. By monitoring the RPM and analyzing harmonic content, maintenance personnel can identify and address defects before they lead to significant machinery failure or downtime.

The graphs 260, 270, and 280 can provide a detailed depiction of how varying load the harmonic content of vibration signals in a rotating machinery system. This information, which can be derived using the system 101 and/or the approaches of system 130, the method 170, and/or the various algorithms discussed herein, underscores the system's capability to use vibration data for accurate RPM estimation and fault diagnosis, enhancing operational efficiency and reducing maintenance costs.

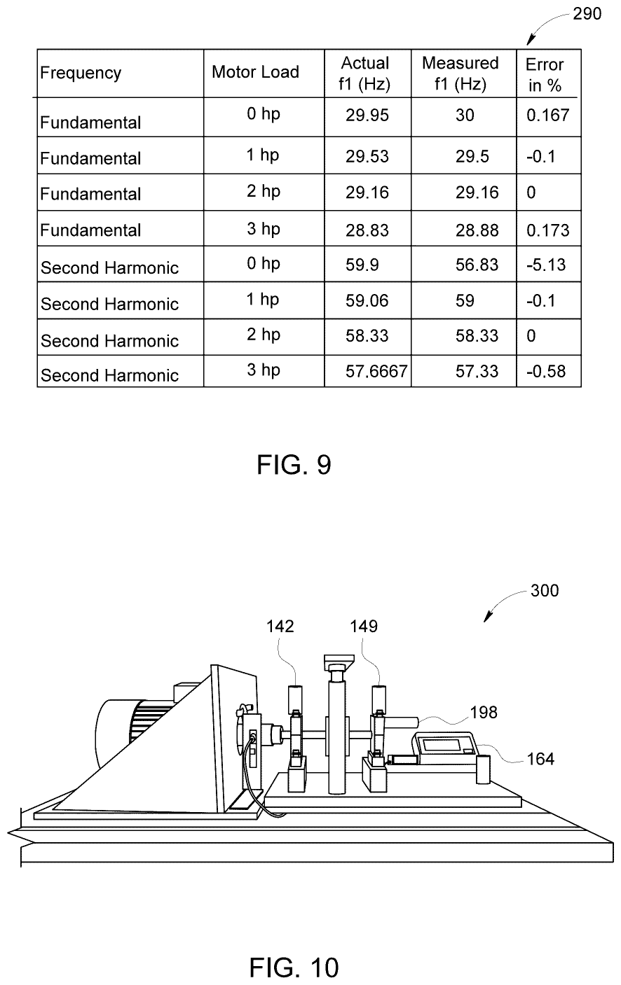

FIG. 9 illustrates a table 290 depicting data indicative of output for a CRWU data set, in accordance with an example embodiment. That is, FIG. 9 presents the detailed table 290, which contains various data elements representing the output results from a specific Case Western Reserve University (CRWU) data set. This table conveys critical insights and findings derived from the CRWU data analysis, particularly in the context of monitoring and evaluating motor load performance. The CRWU datasets are well-known for their comprehensive collection of motor data, used extensively in fault diagnosis and predictive maintenance research. These datasets typically include measurements of vibration, temperature, and other critical parameters under various conditions and fault scenarios.

One of the key columns in table 290 is the frequency column shown at the left side of table 290, which highlights frequency information, including both the fundamental frequency and the second harmonic frequency. These frequencies are crucial for understanding the operational characteristics of the motor load. The fundamental frequency represents the primary operating frequency of the motor, while the second harmonic provides insights into any periodic distortions or harmonics generated during operation.

Another significant aspect captured in the table is error metrics. These metrics help in identifying discrepancies and potential issues in the motor's performance. The errors could be quantified in terms of deviation from expected performance, irregularities in motor behavior, or any other anomalies detected through the analysis of the CRWU data. This column is vital for maintenance and troubleshooting purposes, ensuring that the motor operates efficiently and within safe parameters.

The table 290 includes a comparison between actual and measured values. This comparison is essential for validating the accuracy and reliability of the motor's sensors and monitoring systems. By juxtaposing the expected (actual) values with the observed (measured) values, it is possible to assess the performance of the monitoring system and identify any calibration issues or sensor faults.

Each row and column in the table is structured to provide specific information related to the motor load's performance. Columns might represent different attributes such as frequency, errors, and value comparisons, while rows could denote individual data entries, time stamps, or different operating conditions. This comprehensive overview allows for detailed analysis and facilitates the identification of trends and patterns.

The depiction of table 290 in FIG. 9 is based on an example embodiment, illustrating one possible implementation of how CRWU data can be organized and analyzed. This embodiment helps in understanding the practical application of the concepts and techniques discussed, particularly in the context of motor load monitoring and evaluation. The data from CRWU datasets is highly valuable for research and development in fields such as predictive maintenance, fault detection, and diagnostics. By leveraging these datasets, researchers and engineers can develop more robust models and techniques for ensuring the reliable operation of motors and other machinery.

FIG. 10 illustrates an image of an experimental bearing simulator setup 300, in accordance with an embodiment. The experimental bearing simulator setup 300 shown in FIG. 10 can be configured to simulate various conditions and operational scenarios for bearing systems, allowing researchers to study their behavior under controlled environments. The simulator setup 300 includes bearings mounted on a test rig, along with sensors and measurement equipment to monitor various parameters such as vibration, temperature, and rotational speed.

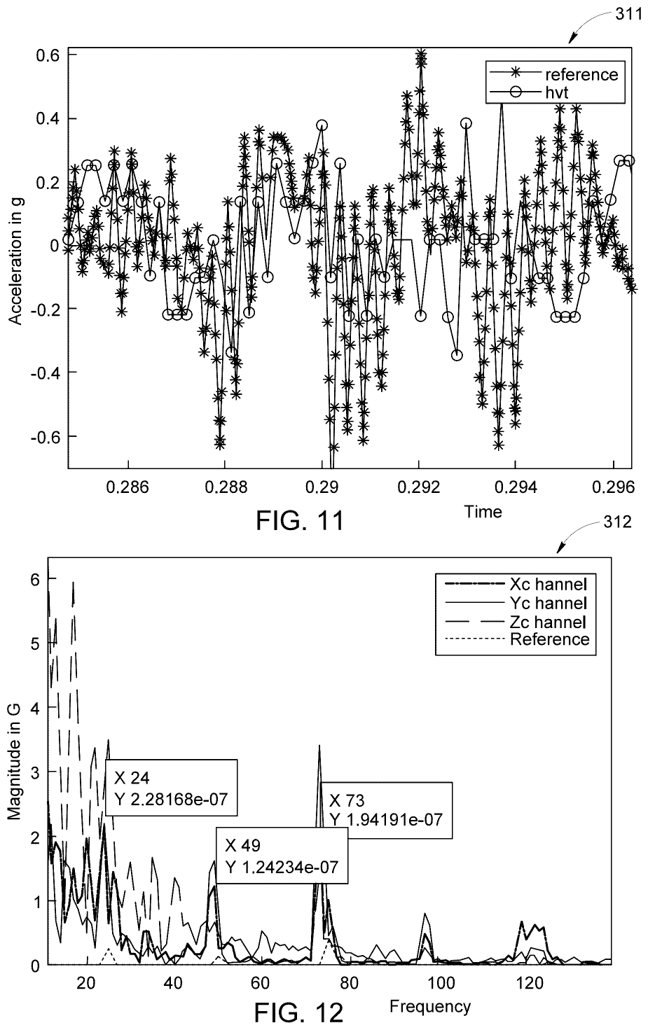

FIG. 11 illustrates a graph 311 depicting time series data obtained from HVT and piezoelectric references sensors, in accordance with an embodiment. The graph 311 presents time series data obtained from both HVT (Honeywell Versatilis Transmitter) (sensors and piezoelectric reference sensors). Note that HVT sensors are advanced devices designed to measure high-frequency vibrations with great accuracy. They are particularly useful in applications requiring detailed vibration analysis, such as fault detection and predictive maintenance in machinery.

The aforementioned reference sensors may be implemented in some embodiments as piezoelectric reference sensors that can utilize the piezoelectric effect to measure changes in pressure, acceleration, temperature, strain, or force by converting them to an electrical charge. Such reference sensors can be used as a benchmark or reference due to their high sensitivity and accuracy in capturing vibrational data. Graph 311 illustrates how the data from these sensors correlates over time, highlighting any discrepancies, patterns, or anomalies in the vibration signals recorded during the experimental runs.

FIG. 12 illustrates a graph 312 depicting RPM values and associated harmonics for three channels of an HVT sensor and a reference sensor, in accordance with an embodiment. The graph 312 shown in FIG. 12 depicts RPM (Revolutions Per Minute) values and associated harmonics captured by three channels of an HVT sensor, alongside a reference sensor. These channels refer to different axes or points of measurement on the HVT sensor, allowing for a comprehensive capture of the vibrational data in multiple dimensions. The reference sensor can serve as a standard or baseline to compare the readings obtained from the HVT sensor. By comparing the data from both the HVT sensor and the reference sensor, it is possible to validate the accuracy of the HVT sensor and ensure the reliability of the measurements. Graph 312 thus illustrates how the RPM values and their harmonics vary across the channels, which can be used to provide further insights into the rotational dynamics and any harmonic distortions present in the system.

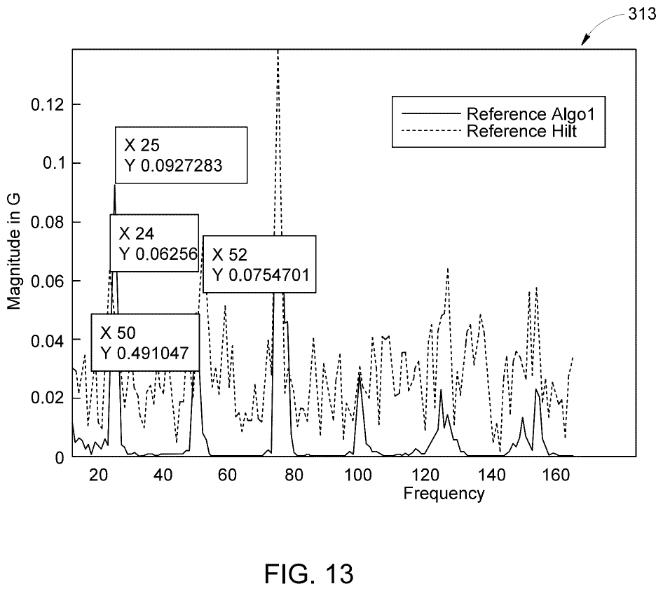

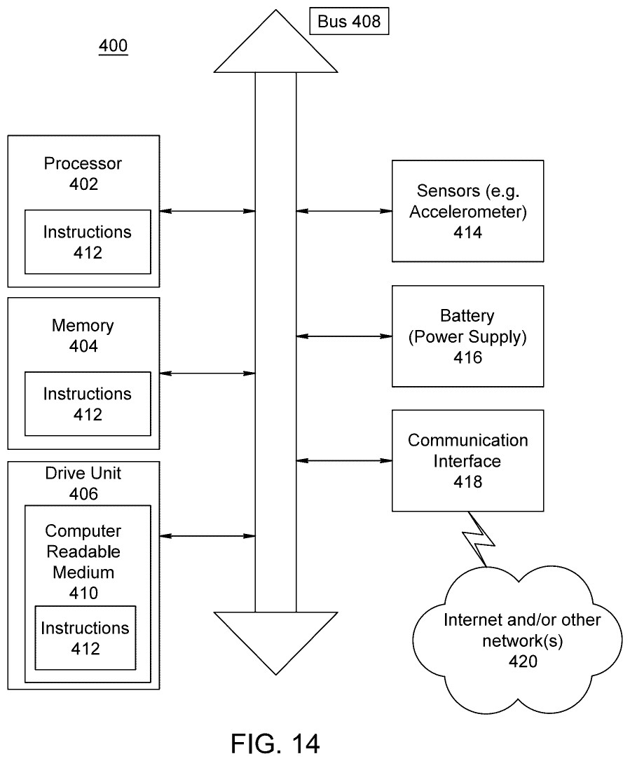

FIG. 13 illustrates a graph 313 depicting RPM values and associated harmonics for the reference sensor with and without a Hilbert Transform, in accordance with an embodiment. The graph 313 shows the RPM values and associated harmonics for reference piezoelectric sensor. Note that the Hilbert transform is a mathematical operation that can be used to derive the analytic representation of a real-valued signal. It may be particularly useful in signal processing for extracting the instantaneous amplitude and phase information of a signal, which helps in analyzing its frequency content. The impact and influence of the Hilbert transform must be understood clearly at various test conditions to realize the impact of modulation and carrier energy suppression. Otherwise, it can alter the frequency content in the vibration signal.

By employing a Hilbert transform, the disclosed method enhances the capability of the HVT sensor to detect and analyze harmonics more accurately. The graph illustrates how this advanced configuration improves the sensor's ability to capture detailed RPM values and their harmonics, providing a more precise and comprehensive understanding of the rotational behavior of the system.

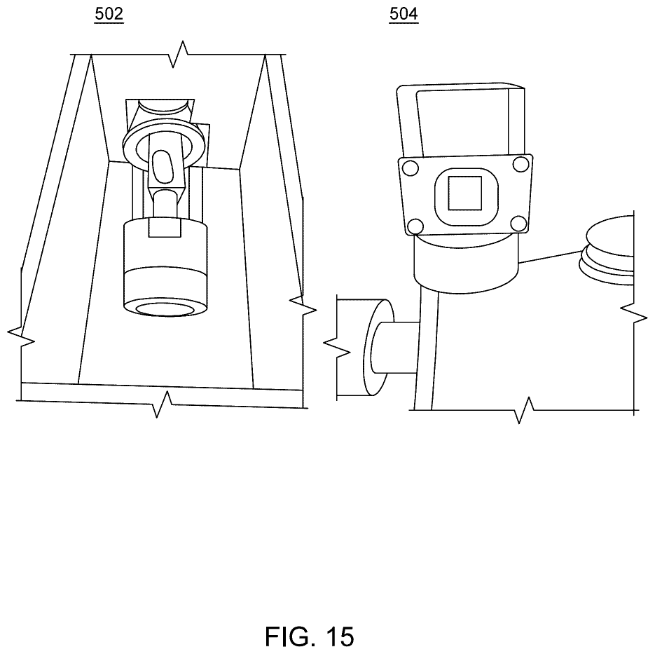

Referring now to FIG. 14 an illustrative embodiment of a computer system 400 is shown. The computer system 400 can include a set of instructions that can be executed to cause the computer system 400 to perform any one or more of the methods or computer-based functions disclosed herein, or aspects of the disclosed embodiments. The computer system 400 may operate as a standalone device or may be connected, e.g., using a network, to other computer systems or peripheral devices. Any of the components discussed herein, such as processor 402, may be a computer system 400 or a component in the computer system 400. The computer system 400 may be specifically configured to implement the disclosed data compression method and related aspects, of which the disclosed embodiments can be a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 200 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 14, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, specifically configured processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to, computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory.

The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the computer system 400 may further communicate with one or more sensors such as s sensor 414 (e.g., accelerometer and/or other types of sensors/transmitters). The sensor 414 may communicate with the processor 402, and/or with the software stored in the memory 404 or in the drive unit 406. Additionally, the computer system 400 may communicate with a battery (power supply) device 416.

In a particular embodiment, as depicted in FIG. 14, the computer system 400 may also include a disk or optical drive unit 406. The disk drive unit 406 may include a computer-readable medium 410 in which one or more sets of instructions 212, e.g., software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed herein.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, or any other components in system 400, or combinations thereof. The connection with the network 420 may be a physical connection, such as a wired Ethernet connection or may be established wirelessly. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to, TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions.

The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated or otherwise specifically configured hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

As used herein, the terms “microprocessor” or “general-purpose processor” (“GPP”) may refer to a hardware device that fetches instructions and data from a memory or storage device and executes those instructions (for example, an Intel Xeon processor or an AMD Opteron processor) to then, for example, process the data in accordance therewith. The term “reconfigurable logic” may refer to any logic technology whose form and function can be significantly altered (i.e., reconfigured) in the field post-manufacture as opposed to a microprocessor, whose function can change post-manufacture, e.g., via computer executable software code, but whose form, e.g., the arrangement/layout and interconnection of logical structures, is fixed at manufacture.

The term “software” may refer to data processing functionality that is deployed on a GPP. The term “firmware” may refer to data processing functionality that is deployed on reconfigurable logic. One example of a reconfigurable logic is a field programmable gate array (“FPGA”) which is a reconfigurable integrated circuit. An FPGA may contain programmable logic components called “logic blocks”, and a hierarchy of reconfigurable interconnects that allow the blocks to be “wired together”, somewhat like many (changeable) logic gates that can be inter-wired in (many) different configurations. Logic blocks may be configured to perform complex combinatorial functions, or merely simple logic gates like AND, OR, NOT and XOR. An FPGA may further include memory elements, which may be simple flip-flops or more complete blocks of memory.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well. Feedback provided to the user can be any form of sensory feedback, e.g., visual feedback, auditory feedback, or tactile feedback. Input from the user can be received in any form, including acoustic, speech, or tactile input.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The flow charts and block diagrams in the figures illustrate the architecture, functionality, and operation of possible implementations of systems, methods, and computer program products according to various embodiments (e.g., preferred or alternative embodiments). In this regard, each block in the flow charts or block diagrams depicted and described herein can represent a module, segment, or portion of instructions, which can comprise one or more executable instructions for implementing the specified logical function(s).

In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that can perform the specified functions or acts or carry out combinations of special purpose hardware and computer instructions.

Note that Samples results from the previously discussed experimental bearing simulator setup 300 are tabulated in the Table I below (apart from previously discussed graphs 311, 312 and 313). Table I shows the accuracy of the algorithm in estimating the RPM of the machine at variable operating speed. Table I also demonstrates a comparison of the RPM measured using tachometer with that of estimated value of the RPM from the HVT and reference piezoelectric sensor. It can be observed that the accuracy of the algorithm is sufficient for estimating the RPM at variable speed for both sensor and are in par with the tachometer.

TABLE I
RPM COMPARISON OF TACHOMETER,
HVT SENSOR & PIEZO SENSOR

| | | |
|---|---|---|
| Actual RPM | Estimated RPM | Estimated RPM of |
| Measured | from HVT Sensor | Piezoelectric Sensor |

| Tachometer | Estimated | % | Estimated | % |
|---|---|---|---|---|
| RPM | RPM | Error | RPM | Error |
| 600 | 600 | 0 | 600 | 0 |
| 800 | 780 | 2.5 | 798 | 0.25 |
| 1000 | 960 | 4 | 1002 | −0.2 |
| 1200 | 1140 | 5 | 1200 | 0 |
| 1500 | 1440 | 4 | 1500 | 0 |

FIG. 15 illustrates images of a test configuration conducted on a pump-motor setup using an HVT sensor at a variable speed. A test can be conducted on the pump-motor setup using HVT sensor at variable speed as shown in the FIG. 15. The estimated RPM shown in FIG. 15 can be tabulated as shown in Table II. It can be observed from the results that the estimated RPM using HVT device is greater than 98% at variable speed of the motor. It can be concluded that this edged based signal processing algorithm can be used on the low-cost controller to estimate RPM at variable speed with accuracy close to 95%.

TABLE II
RPM COMPARISON OF TACHOMETER, HVT SENSOR

| | | Estimated | |
|---|---|---|---|
| VFD | Tachometer | RPM | % |
| Freq-Hz | RPM | (HVT) | Error |
| 25 | 1465 | 1492 | −1.84 |
| 28 | 1634 | 1607 | 1.65 |
| 30 | 1750 | 1722 | 1.6 |
| 33 | 1916 | 1952 | −1.87 |
| 35 | 2030 | 2067 | −1.82 |
| 38 | 2193 | 2182 | 0.5 |
| 40 | 2312 | 2296 | 0.69 |
| 43 | 2466 | 2411 | 2.23 |

Based on the foregoing, it can be appreciated that a number of different embodiments are disclosed herein. For example, in an embodiment, a method for estimating revolution per minute (RPM) of rotating machinery, can involve: acquiring vibration data from an accelerometer sensor mounted on the rotating machinery; detecting vibration signals from the acquired vibration data; performing a Fast Fourier Transform (FFT) on the detected vibration signals for conversion of the detected vibration signals from a time domain to a frequency domain; estimating an RPM of the rotating machinery from the frequency domain; calculating fault frequencies using the estimated RPM and a bearing configuration provided by a user; and diagnosing a health status of the rotating machinery based on the calculated fault frequencies and an analysis of the detected vibration signals.

In an embodiment, the accelerometer sensor can be a MEMS capacitive accelerometer sensor.

An embodiment can further involve standardizing the vibration data across three axes.

An embodiment may also involve standardizing the vibration data across three axes to improve transient and DC offset correction.

An embodiment can further involve filtering the standardized vibration data using a bandpass filter determined by a predefined range and detecting peaks within the filtered vibration data to refine the estimation of the RPM.

In an embodiment, the RPM estimation and fault diagnosis can be performed using an adaptive configurable ‘g’ setting to ensure accurate RPM determination under variable speeds and torque conditions using low cost sensing and processing system.

In an embodiment, a system for estimating RPM of rotating machinery, can include at least one processor and a non-transitory computer-usable medium embodying computer program code, the computer-usable medium capable of communicating with the at least one processor. The computer program code can comprise instructions executable by the at least one processor and configured for: acquiring vibration data from an accelerometer sensor mounted on the rotating machinery; detecting vibration signals from the acquired vibration data; performing a Fast Fourier Transform (FFT) on the detected vibration signals for conversion of the detected vibration signals from a time domain to a frequency domain; estimating an RPM of the rotating machinery from the frequency domain; calculating fault frequencies using the estimated RPM and a bearing configuration provided by a user; and diagnosing a health status of the rotating machinery based on the calculated fault frequencies and an analysis of the detected vibration signals.

In an embodiment of the system, the accelerometer sensor can be a MEMS capacitive accelerometer sensor.

In an embodiment of the system, the instructions can be further configured for standardizing the vibration data across three axes to improve transient and DC offset correction.

In an embodiment of the system, the instructions can be further configured for filtering the standardized vibration data using a bandpass filter determined by a predefined range and detecting peaks within the filtered vibration data to refine the estimation of the RPM.

In an embodiment of the system, the RPM estimation and fault diagnosis can be performed using an adaptive configurable ‘g’ setting to ensure accurate RPM determination under variable speeds and torque conditions using low cost sensing and processing system.

In an embodiment, a sensor apparatus can include: an accelerometer sensor mounted on rotating machinery, wherein the accelerometer acquires vibration data from the rotating machinery and vibration signals are detected from the acquired vibration data, and wherein a Fast Fourier Transform (FFT) can be performed on the detected vibration signals for conversion of the detected vibration signals from a time domain to a frequency domain. In addition, an RPM of the rotating machinery can be estimated from the frequency domain, and fault frequencies can be calculated using the estimated RPM and a bearing configuration. Furthermore, the health status of the rotating machinery can be diagnosed based on the calculated fault frequencies and an analysis of the detected vibration signals.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A method for estimating RPM of rotating machinery, comprising:
acquiring vibration data from an accelerometer sensor mounted on the rotating machinery;
detecting vibration signals from the acquired vibration data;
performing a Fast Fourier Transform (FFT) on the detected vibration signals for conversion of the detected vibration signals from a time domain to a frequency domain;
estimating an RPM of the rotating machinery from the frequency domain;
calculating fault frequencies using the estimated RPM and a bearing configuration provided by a user; and
diagnosing a health status of the rotating machinery based on the calculated fault frequencies and an analysis of the detected vibration signals.

2. The method of claim 1 wherein the accelerometer sensor comprises a MEMS capacitive accelerometer sensor.

3. The method of claim 1 further comprising standardizing the vibration data across three axes.

4. The method of claim 1 further comprising standardizing the vibration data across three axes to improve transient and DC offset correction.

5. The method of claim 4 further comprising:
filtering the standardized vibration data using a bandpass filter determined by a predefined range; and
detecting peaks within the filtered vibration data to refine the estimation of the RPM.

6. The method of claim 4 further comprising filtering the standardized vibration data using a bandpass filter determined by a predefined range.

7. The method of claim 4 further comprising detecting peaks within filtered vibration data to refine the estimation of the RPM.

8. The method of claim 1 wherein the RPM estimation and fault diagnosis are performed using an adaptive configurable ‘g’ setting to ensure accurate RPM determination under variable speeds and torque conditions using low cost sensing and processing system.

9. A system for estimating RPM of rotating machinery, comprising:
at least one processor; and
a non-transitory computer-usable medium embodying computer program code, the computer-usable medium capable of communicating with the at least one processor, the computer program code comprising instructions executable by the at least one processor and configured for:
acquiring vibration data from an accelerometer sensor mounted on the rotating machinery;
detecting vibration signals from the acquired vibration data;
performing a Fast Fourier Transform (FFT) on the detected vibration signals for conversion of the detected vibration signals from a time domain to a frequency domain;
estimating an RPM of the rotating machinery from the frequency domain;
calculating fault frequencies using the estimated RPM and a bearing configuration provided by a user; and
diagnosing a health status of the rotating machinery based on the calculated fault frequencies and an analysis of the detected vibration signals.

10. The system of claim 9 wherein the accelerometer sensor comprises a MEMS capacitive accelerometer sensor.

11. The system of claim 9 wherein the instructions are further configured for standardizing the vibration data across three axes to improve transient and DC offset correction.

12. The system of claim 11 wherein the instructions are further configured:
filtering the standardized vibration data using a bandpass filter determined by a predefined range; and
detecting peaks within the filtered vibration data to refine the estimation of the RPM.

13. The system of claim 9 wherein the RPM estimation and fault diagnosis are performed using an adaptive configurable ‘g’ setting.

14. The system of claim 9 wherein the RPM estimation and fault diagnosis are performed using an adaptive configurable ‘g’ setting to ensure accurate RPM determination under variable speeds and torque conditions using low cost sensing and processing system.

15. A sensor apparatus, comprising:
an accelerometer sensor mounted on rotating machinery, wherein the accelerometer acquires vibration data from the rotating machinery and vibration signals are detected from the acquired vibration data;
wherein a Fast Fourier Transform (FFT) is performed on the detected vibration signals for conversion of the detected vibration signals from a time domain to a frequency domain;
wherein an RPM of the rotating machinery is estimated from the frequency domain;
wherein fault frequencies are calculated using the estimated RPM and a bearing configuration; and
wherein a health status of the rotating machinery is diagnosed based on the calculated fault frequencies and an analysis of the detected vibration signals.

16. The sensor apparatus of claim 15 wherein the bearing configuration is provided by a user.

17. The sensor apparatus of claim 15 wherein the accelerometer sensor comprises a MEMS capacitive accelerometer sensor.

18. The sensor apparatus of claim 15 further comprising a bandpass filter.

19. The sensor apparatus of claim 18 wherein standardized vibration data is filtered using the bandpass filter determined by a predefined range and wherein peaks within the filtered vibration data are detected to refine the estimation of the RPM.

20. The sensor apparatus of claim 15 wherein the RPM estimation and fault diagnosis are performed using an adaptive configurable ‘g’ setting to ensure accurate RPM determination under variable speeds and torque conditions using low cost sensing and processing system.
